(19) United States
(12) Patent Application Publication
(10) Pub. No.: US 2025/0015605 A1
(43) Pub. Date: Jan. 9, 2025

(54) APPARATUS AND SYSTEM FOR PROVIDING STACKED-SERIAL BATTERY CHARGING OF REMOVABLE BATTERY PACKS

(71) Applicant: HUSQVARNA AB, Huskvarna (SE)

(72) Inventor: Daniel Booth, Charlotte, NC (US)

(21) Appl. No.: 18/764,325

(22) Filed: Jul. 4, 2024

Related U.S. Application Data
(60) Provisional application No. 63/525,210, filed on Jul. 6, 2023.

(51) Int. Cl. H02J 7/00; H01M 10/44; H02J 7/04

(52) U.S. Cl. CPC H02J 7/0013; H01M 10/441; H02J 7/04; H02J 7/007182

(57) ABSTRACT

A method of charging a plurality of battery packs may include applying a first constant current to a battery for a first period of time until a first charging voltage value is reached for the battery to define a first charging stage, applying a second constant current to the battery for a second period of time until a second charging voltage value is reached for the battery to define a second charging stage, and sequentially repeating application of the first and second charging stages to one or more additional batteries such that each of the one or more additional batteries enters the first charging stage when a previous battery in the first charging stage transitions to the second charging stage, and the each of the one or more additional batteries transitions to the second charging stage upon completing the first charging stage until all of the battery and the one or more additional batteries achieve a desired state of charge.

### TECHNICAL FIELD

Example embodiments generally relate to battery technology and, more particularly, relate to a battery charging technique, and device and system for employing such technique, which is useable to efficiently charge multiple batteries.

### BACKGROUND

Property maintenance tasks are commonly performed using various tools and/or machines that are configured for the performance of corresponding specific tasks. Certain tasks, like cutting trees, trimming vegetation, blowing debris and the like, are typically performed by hand-held tools or power equipment. The hand-held power equipment may often be powered by gas or electric motors. Similarly, walk-behind and ride-on outdoor power equipment are used for specific tasks like lawn mowing, tilling, etc., and these devices can have gas or electric motors.

Until the advent of battery powered electric tools/vehicles, gas powered motors were often preferred by operators that desired, or required, a great deal of mobility. Accordingly, many outdoor power equipment devices are powered by gas motors because they may be required to operate over a relatively large range. However, as battery technology continues to improve, the robustness of battery powered equipment has also improved and such devices have increased in popularity.

The batteries employed in outdoor power equipment may, in some cases, be removable and/or rechargeable assemblies of a plurality of smaller cells that are arranged together in order to achieve desired output characteristics. The groups of smaller cells may be located or housed within a housing to form a battery pack. The battery pack may be charged, used, and recharged and, for some larger jobs, operators may plan ahead to have multiple batteries charging while others are in use so that power is continuously available. Particularly when many devices, and therefore also many batteries, are being used, the demands of battery charging may become substantial. In the US, or anywhere else where there are common practical limitations that apply based on supply voltage or current limitations, batteries may need to be charged in series, and the time to do so may be substantial. Thus, it may be necessary to develop new and more efficient ways of achieving serial charging of multiple battery packs.

### BRIEF SUMMARY OF SOME EXAMPLES

In one example embodiment, a method of charging a plurality of battery packs may be provided. The method may include applying a first constant current to a battery for a first period of time until a first charging voltage value is reached for the battery to define a first charging stage, applying a second constant current to the battery for a second period of time until a second charging voltage value is reached for the battery to define a second charging stage, and sequentially repeating application of the first and second charging stages to one or more additional batteries such that each of the one or more additional batteries enters the first charging stage when a previous battery in the first charging stage transitions to the second charging stage, and the each of the one or more additional batteries transitions to the second charging stage upon completing the first charging stage until all of the battery and the one or more additional batteries achieve a desired state of charge.

In another example embodiment, an expansion array for enabling charging of a plurality of battery packs via a single charger to which the expansion array is operably coupled may be provided. The expansion array may include a plurality of charge ports into which respective ones of the battery packs are installed for charging, and a power controller. The power controller may be configured for applying a first constant current to a battery inserted into one of the charge ports for a first period of time until a first charging voltage value is reached for the battery to define a first charging stage, applying a second constant current to the battery for a second period of time until a second charging voltage value is reached for the battery to define a second charging stage, and sequentially repeating application of the first and second charging stages to one or more additional batteries inserted into respective other ones of the charge ports such that each of the one or more additional batteries enters the first charging stage when a previous battery in the first charging stage transitions to the second charging stage, and the each of the one or more additional batteries transitions to the second charging stage upon completing the first charging stage until all of the battery and the one or more additional batteries achieve a desired state of charge.

In yet another example embodiment, a charging system for charging a plurality of battery packs may be provided. The system may include a battery charger for converting AC input power into DC output power for charging the battery packs, and an expansion array operably coupled to the battery charger to receive the DC output power. The expansion array may include a plurality of charge ports into which respective ones of the battery packs are installed for charging and a power controller. The power controller may be configured for applying a first constant current to a battery of one of the battery packs for a first period of time until a first charging voltage value is reached for the battery to define a first charging stage, applying a second constant current to the battery for a second period of time until a second charging voltage value is reached for the battery to define a second charging stage, and sequentially repeating application of the first and second charging stages to one or more additional batteries of respective ones of the battery packs such that each of the one or more additional batteries enters the first charging stage when a previous battery in the first charging stage transitions to the second charging stage, and the each of the one or more additional batteries transitions to the second charging stage upon completing the first charging stage until all of the battery and the one or more additional batteries achieve a desired state of charge.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a prior art charging routine for charging of a lithium ion battery;

FIG. 2 illustrates a block diagram of a system circuitry for charging multiple batteries in a Stacked-Serial charge routine in accordance with an example embodiment;

FIG. 3 illustrates a plot of voltage, current and power characteristics associated with charging a battery via the Stacked-Serial charge routine in accordance with an example embodiment;

FIG. 4 illustrates a plot of voltage, current and power characteristics associated with charging two batteries in respective different stages simultaneously via the Stacked-Serial charge routine in accordance with an example embodiment;

FIG. 5 compares power variation of a conventional charge routine to that of the Stacked-Serial charge routine in accordance with an example embodiment;

FIG. 6 illustrates a plot of power versus time for implementation of the Stacked-Serial charge routine in accordance with an example embodiment with a first current limit;

FIG. 7 illustrates a plot of power versus time for implementation of the Stacked-Serial charge routine in accordance with an example embodiment with a second current limit;

FIG. 8 illustrates a plot of state of charge in various time steps associated with two stages of charging of a series of six fully discharged batteries in accordance with an example embodiment;

FIG. 9 illustrates a plot of state of charge in various time steps associated with two stages of charging of a series of six batteries having different states of charge in which the batteries with the highest initial state of charge are first to be charged in accordance with an example embodiment;

FIG. 10 illustrates a plot of state of charge in various time steps associated with two stages of charging of a series of six batteries having different states of charge in which the batteries with the highest initial state of charge are last to be charged in accordance with an example embodiment; and

FIG. 11 illustrates a method of charging a plurality of batteries in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection or interaction of components that are operably coupled to each other. Additionally, the terms “battery” and “battery pack” are used interchangeably herein.

For the reasons noted above, battery charging technology must advance with the pace of advancement of battery technology itself. In this regard, methods for charging batteries require variable power over the duration of the charging process. The requirement for variable power is based on the charging algorithm adopted. The algorithm employed is limited by the capabilities of the battery charger and designed to meet the physical requirements of the battery construction as well as the chemistry of its constituent cells. The battery requirements take the form of limitations on the magnitude of charge voltage and charge current, which vary depending on each other, cell temperature, the battery state of charge (SOC), and an inevitably diminishing battery charge capacity. Failure to meet these requirements can result in battery accelerated aging or catastrophic failure; regardless of meeting these requirements the algorithm employed will affect the rate at which the battery charge capacity diminishes with each instance of a battery charging.

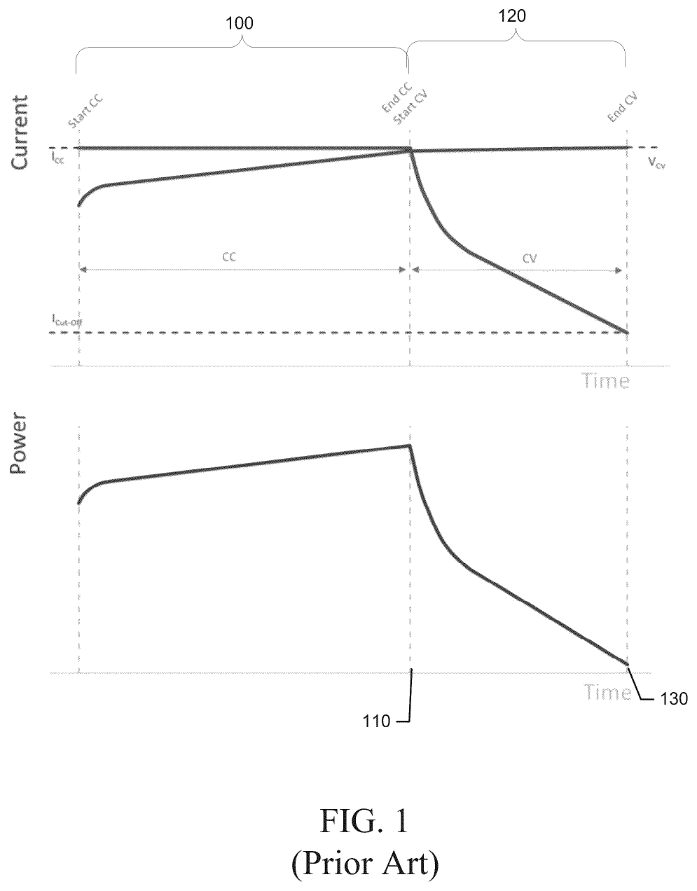

The prevailing routine used for charging Li-Ion batteries today is the constant current/constant voltage (CC/CV) method with most alternatives involving some minor variation on this method. This method is illustrated in FIG. 1 and involves initially supplying a constant measure of current to the battery while the battery voltage increases in region 100. This is continued until the point when the maximum safe voltage is achieved at point 110. At this point, the maximum safe voltage is held and current is allowed to depreciate as the battery's SOC and internal resistance evolve in region 120. Once a minimum charge current is encountered the charging process terminates and the battery is considered completely charged (100% SOC) at point 130. This charge routine is easy to implement with minimal hardware and uncomplicated software, and it is considered safe over the range beginning anywhere above some minimum initial SOC and up until 100% SOC.

The power available to a battery charger is limited by the product of the voltage delivered by the power supply and the current rating of the circuit breaker bridging the connection to the power supply. If a single charger or multiple chargers running concurrently at any point in the charging process exceed this power demand, the supply infostructure risks incurring damage and precautionary measures such as the activation of circuit breakers or fuses are relied upon to minimize such damage. As an example, a North American commercial outlet supplies 120V with a 20 A breaker and continuous power supply is restricted to 80% of the rating of the breaker, which is 1920 W and with supply line losses of 10V this brings the supply down to 1760 W. If a charger is only 85% efficient then only 1496 W can be supplied and three 500 W chargers charging 3 batteries in parallel have the potential of tripping the circuit breaker. A standard 500 W charger only operates at max power for a short period as can be seen in FIG. 1. In this way limiting the variation in power demand during the charging process allows for more charging systems to be run concurrently without risking system overload.

If a multitude of batteries need to be charged over a limited period of time, a charging routine that maintains a tight lower bound on power delivered to the batteries and upper bound on power required from a supply can be used to achieve this goal. At the same time this routine would still be restricted to the charging requirements of the particular battery.

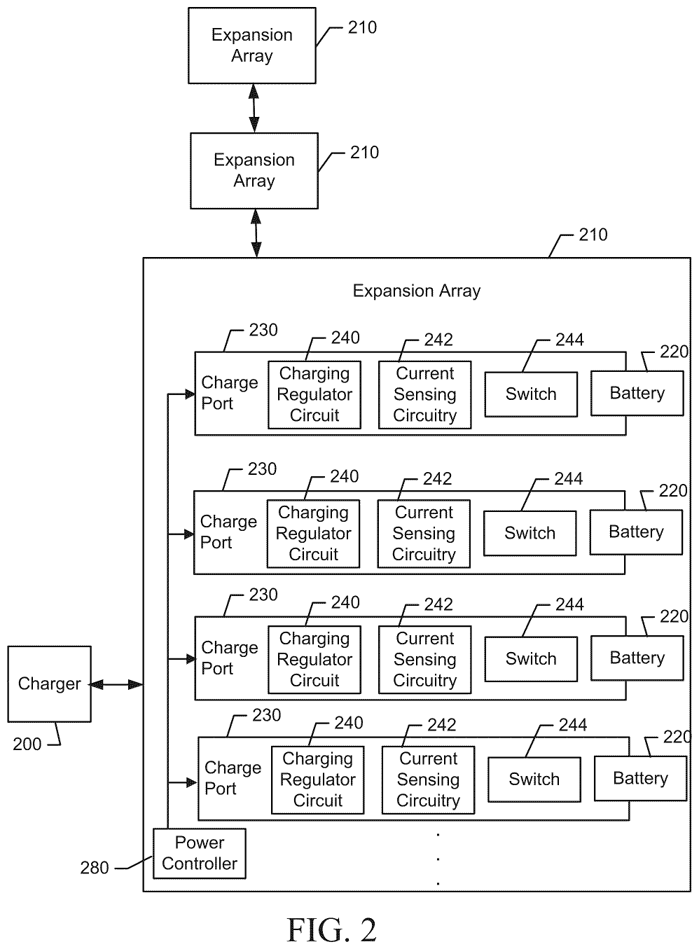

FIG. 2 illustrates a schematic diagram of a battery charger 200 operably coupled to an expansion array 210 aimed at increasing the capacity of the battery charger 200 to charge multiple batteries 220. The internal electronics of the battery charger 200 are outside the scope of this invention, and therefore will not be discussed in detail. However, it can be appreciated that the battery charger 200 includes circuitry for converting AC inlet power into DC charging power that is operably coupled to the expansion array 210. The expansion array 210 may include multiple charge ports 230 to which each of the batteries 220 are connectable. Each of the charge ports 230 may include a charging regulator circuit 240, current sensing circuitry 242 and switch 244 to control the application of charging power to a corresponding one of the batteries 220 in a respective one of the charge ports 230. The expansion array 210 may also include a power controller 280, which may include processing circuitry (e.g., a processor and memory) configured to employ a control algorithm for various other components of the expansion array 210 (e.g., the charging regulator circuit 240 and/or the switch 244), based on information regarding charging current and voltages applied to the batteries 220, to employ a charging method or routine as described herein.

Notably, although only four instances of charge ports 230 and batteries 220 are shown in FIG. 2, any suitable number of charge ports 230 may be included in some cases. Additionally, additional instances of the expansion array 210 may be operably coupled to a single instance of the battery charger 200. Thus, for example, FIG. 2 shows three separate instances of the expansion array 210 serially connected to the battery charger 200. It will further be appreciated that voltage supply, current supply and/or power supply limits may ultimately dictate the maximum number of charge ports 230 and/or expansion arrays 210. However, the operational dictates of the charging method described herein generally provides for an efficient charging method in the presence of any restriction on these parameters by increasing efficiency of charging based on the methodology employed instead of simply increasing power delivery capacity.

The system shown in FIG. 2 employs the battery charger 200 to provide DC power to the expansion array 210 with its multiple battery docks or slots (i.e., charge ports 230) that are each capable of providing their own respective DC/DC charge regulation (via the charging regulator circuit 240). If an example embodiment were to employ three instances of the expansion array 210, each of which included six instances of charge ports 230, then each of the eighteen instances of batteries 220 connected to the charge ports 230 may be independently charged via a single charger (i.e., battery charger 200). Under normal circumstances, charge time for each of the batteries 220 to be charged using a serial charge routine such as that of FIG. 1 would not be able to completely charge all 18 instances of the batteries 220 in this system in a 12 hour window. Due to power supply limitations, a parallel charging system also could not simultaneously charge all 18 batteries in this system over 12 hours unless the batteries were of sufficiently small capacity. Accordingly, example embodiments aim to modify the charge routine to provide a more efficient use of available power to increase the amount of batteries that can be charged within a given period of time.

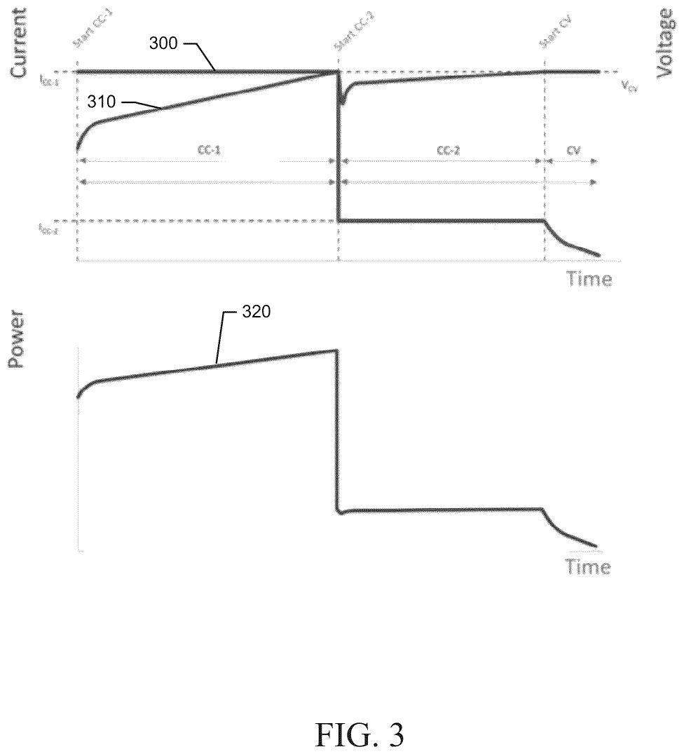

In this regard, some example embodiments may provide a Stacked-Serial charging routine (e.g., executed by the power controller 280) that charges batteries using a variation of the standard CC/CV methodology. The result is a variation in the charging method to a constant current/constant current/constant voltage (CC/CC/CV) charging method that has potential to reduce the speed at which battery capacity diminishes from a large number of charge cycles. The Stacked-Serial charging routine splits the CC/CC/CV charging method or routine into distinct portions that begin execution synchronously on separate batteries. These portions will be referred to as “stages” to allude to the necessity condition that they be executed in an order on any particular battery and despite their synchronous execution over distinct batteries. A basic example of a CC/CC/CV charging method is illustrated in FIG. 3.

Turning now to FIG. 3, the charging method (i.e., a CC/CC/CV example) begins with a period labeled CC-1 in FIG. 3, which shows a charging current curve 300, and an applied voltage curve 310 along with a separate power curve 320, each of which is shown applied over time during a charging operation. CC-1 is a charging period characterized by a constant supply current output (I_{CC-1}) being continuously applied to the battery being charged until a charge voltage (V_{CV}), which may define a maximum charging voltage, is reached a first time. At this point, CC-2 defines a second charging period characterized by a lower constant supply current output (I_{CC-2}), which begins and continues until V_{CV} is reached a second time. The last charging period, CV, begins at this point and a constant application of the charging voltage (V_{CV}) is held while charging current tapers off. The charging period CV concludes after a fixed period of time or once a minimum current is reached, and the battery may be considered to be fully charged at that point (i.e., 100% SOC).

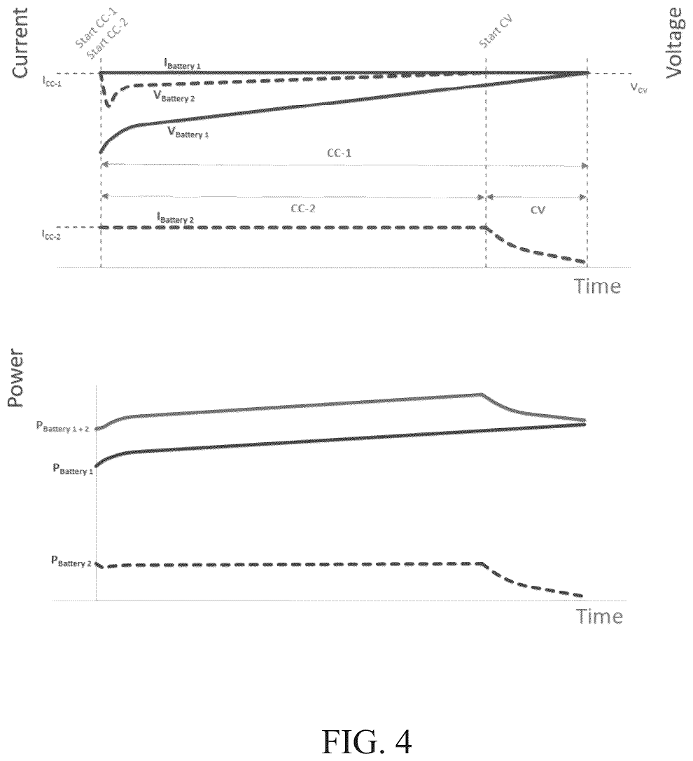

The Stacked-Serial charging routine is not a multi-step constant current charging method, but is instead a way of using multiple constant current steps to charge batteries simultaneously with limits on output and input power variation. If a value of I_{CC-2} is chosen so that the duration of the stage defined by CC-2 through CV is less than, but similar in length to the stage consisting of CC-1, then these stages roughly split the entire charging period into two halves. Thus, one battery (Battery 1) in a series could be charged through the CC-1 stage and another battery (Battery 2), which had previously been charged through the CC-1 stage, could be simultaneously charged through the remaining CC-2 and CV stage. The resulting voltage, current, power, and combined power for these two batteries are displayed in FIG. 4. In this regard, I_{Battery 1} is a higher constant current (I_{CC-1}) and I_{Battery 2} is a lower constant current (I_{CC-2}) and the respective charging voltages V_{Battery 1} and V_{Battery 2} are also shown over periods of constant current (CC-1 and CC-2) and constant voltage (for V_{CV} on the second battery (Battery 2) only). P_{Battery 1} and P_{Battery 2} are also shown along with P_{Battery 1+2} for the respective periods.

A system charging in the manner described above completes a cyclical operation of charging multiple batteries 220 in a fraction of the time it takes for a standard charger routine to complete a charge cycle and a battery is completely charged at the end of each cycle, therefore many more batteries can be charged in the same period if the process is extended over a multitude of batteries. This is possible because the method employed herein provide for at least two batteries to be efficiently charged simultaneously at all times. Within this context, an important aspect of the technique is that the average power delivered to these batteries over the course of the charging process is elevated and maintained at a heightened level with less power variation throughout the entire cycle.

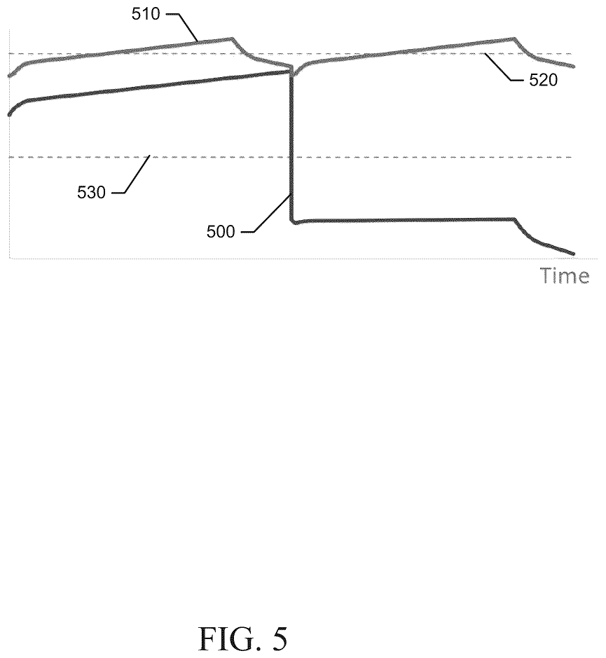

In other words, a key aspect of the advantage gained by employing example embodiments is that there is a relatively small power variation throughout the charging cycle when multiple batteries are simultaneously charged. In this regard, returning to FIG. 1, it can be seen that although there is little power variation during region 100, there is a massive power variation during region 120. Contrast this large power variation over the charging cycle with that achieved in connection with charging multiple batteries as shown in FIG. 4, and the magnitude of improvement can be very much appreciated. This concept is further illustrated in FIG. 5, which compares the power output from a single cycle (1 charged battery) of the system in FIG. 3 (curve 500) to the power output from two cycles (two charged batteries) of the system in FIG. 4 (curve 510). Average output power level over the charging cycle for curve 500 is shown by dotted line 520. Average output power level over the charging cycle for curve 510 is shown by dotted line 530.

Of course, the initial state of charge of the batteries being charged will have some impacts on the timing associated with employing a CC/CC/CV charging method of an example embodiment. However, the improved efficiency, and therefore the ability to charge more batteries fully within the same space of time will apply regardless of the initial states of charge of the batteries being charged when compared to a conventional CC/CV charging method.

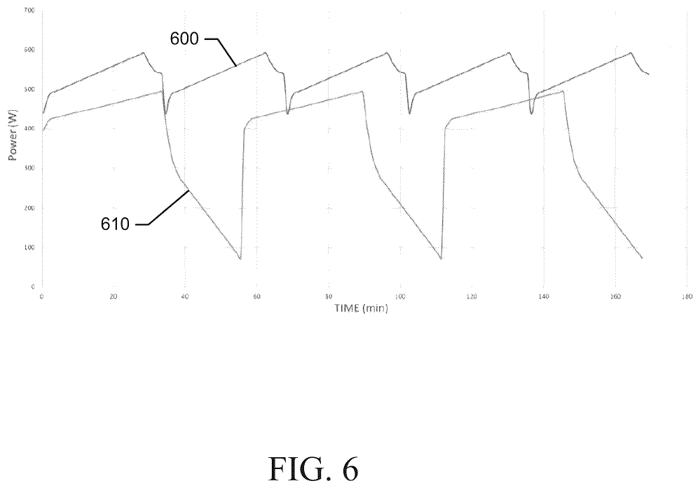

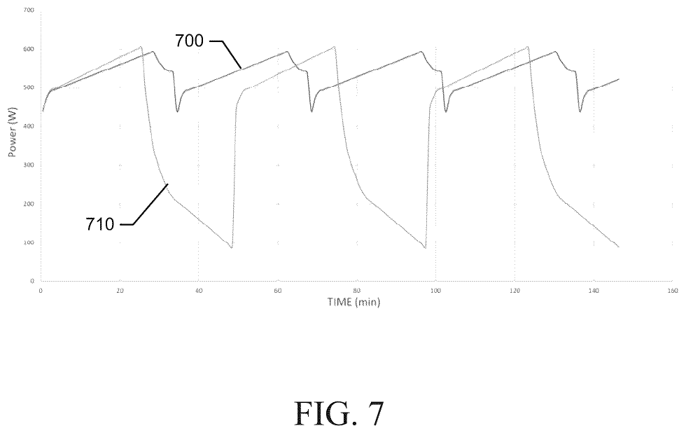

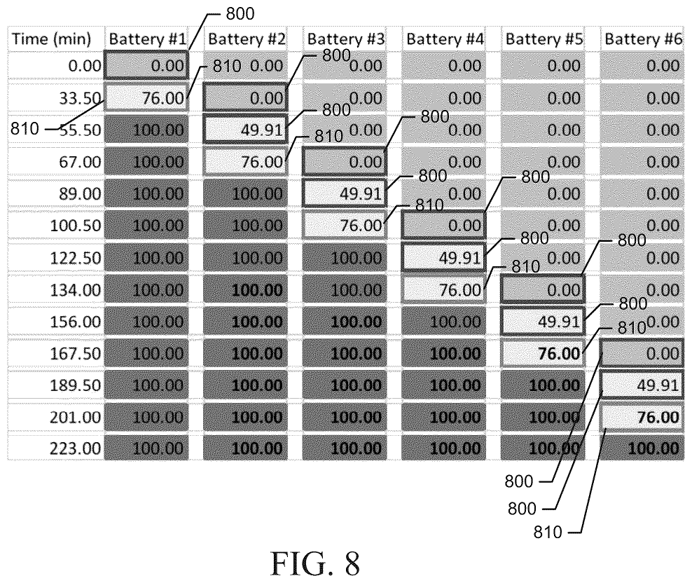

FIGS. 6 and 7 show a theoretical example of serial charging of a multitude of fully discharged commercially available rechargeable batteries used for powering outdoor power equipment with the Stacked-Serial routine using a 500 W Stage 1 and 110 W Stage 2 system (curve 600 in FIG. 6 and curve 700 in FIG. 7). This is compared to serial charging with a 610 W charger, however since the batteries are only rated to be charged at 12 A or less two figures are provided. FIG. 7 includes the actual 12 A limit and each battery can only be charged at up to 500 W (curve 610 in FIG. 6) and FIG. 8 dismisses this limitation and allows for the serial charger to charge up to 14.5 A and utilize the full 610 W (curve 710 in FIG. 7). This 12 A limit does not apply to the Stacked-Serial charger as it is charging two batteries simultaneously without exceeding 12 A into either battery. Each cycle shown represents a battery completely charged.

FIG. 8 illustrates the steps that a Stacked-Serial charge routine with a 500 W Stage 1 that applies a higher constant current while voltage increases to reach a maximum charging voltage (i.e., V_{CV}). The Stacked-Serial charge routine of FIG. 8 also includes a 110 W Stage 2 that applies a lower constant current until the maximum charging voltage is reached again, and then maintains that maximum charging voltage (while current decreases) until a 100% SOC is reached. FIG. 8 illustrates a process for charging six fully discharged batteries (i.e., Battery #1, Battery #2, Battery #3, Battery #4, Battery #5 and Battery #6) where Stage 1 gets each battery to a 76% SOC, and Stage 2 carries each battery on to a 100% SOC.

In the example of FIG. 8, all of Batteries #1-#6 have a 0% SOC initially. From time 0 minutes to time 33.5 minutes, Battery #1 is in Stage 1 charging with a high initial constant current applied until a 76% SOC is achieved in the 33.5 minutes of Stage 1. At time 33.5 minutes, Battery #1 proceeds to Stage 2, and Battery #2 enters into Stage 1. Within FIG. 8, a cell outlined in box 800 indicates that the corresponding battery is in Stage 1, and a cell outlined in box 810 indicates that the corresponding battery is in Stage 2. Whereas Stage 1 generally lasts 33.5 minutes for each cell, Stage 2 generally lasts 20 minutes in this example. Thus, while there is always exactly one other cell in Stage 1 when any given cell is in Stage 2, there is not always another cell in Stage 2, when each cell is in Stage 1 since Stage 1 is longer, and only one cell can be in each of Stages 1 and 2 at any given time.

Following this paradigm, Battery #1 is at 100% SOC after 20 minutes of Stage 2 (which is at 55.5 minutes after start). When Battery #1 completes Stage 2 (and is at 100% SOC), Battery #2 is only at 49.91% SOC in Stage 1, and therefore continues to charge alone (with no other cell being charged) in Stage 1 from 55.5 minutes to 67 minutes, when Battery #2 transitions to Stage 2, and Battery #3 transitions to Stage 1. Thus, it can be appreciated that in the first step, Battery #1 is charged in Stage 1 for 33.5 minutes. In the second step, Battery #2 begins charging in Stage 1 while Battery #1 charges in Stage 2. In the third step, Battery #1 reaches 100% SOC while Battery #2 continues charging in Stage 1. In the fourth step, Battery #1 remains at 100% SOC while Battery #2 begins charging in Stage 2 and Battery #3 begins charging in Stage 1. This paradigm continues until all batteries have been fully charged (i.e., 100% SOC) in 223 minutes.

The fastest a standard serial charge routine could charge each of the six batteries of FIG. 8 is 55.5 minutes for a total charge time of 333 minutes. This means a standard serial charge routine could completely charge only 12 batteries in a 12 hour period while a Stacked-Serial charge routine of an example embodiment could completely charge 20 batteries in the same 12 hour period. To further express the system capability, three such charging systems could be safely run simultaneously on a single North American standard non-residential outlet and 60 batteries could be charged in a 12 hour period.

The examples provided are the most basic application of this routine, however this process can be extended to any number of batteries that synchronously charge over an equal number of stages that partition a single complete battery charge cycle. Increasing this parallel aspect permits higher average charging power and provides the opportunity to further restrict power variation over a charging cycle. The example above illustrates a dividing of the charging routine into roughly equal length stages for simplicity, however appropriate currents can be selected so that particular stages can be shortened which creates the opportunity to split and even introduce delays in charging stages. These could be implemented to introduce their contribution during lulls in the power cycle and further reduce the power variation within a cycle. This routine need not be specific to a particular charger, as nothing about its implementation restricts the charger from performing alternate routines using the existing hardware if routine selection is available.

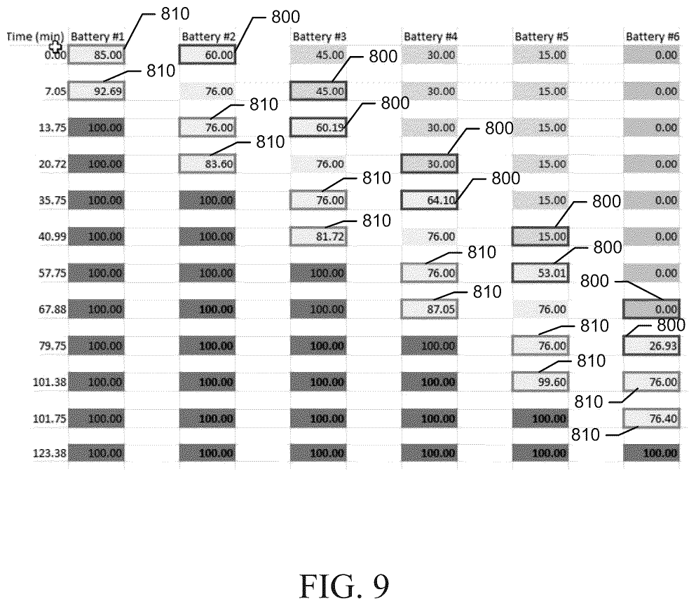

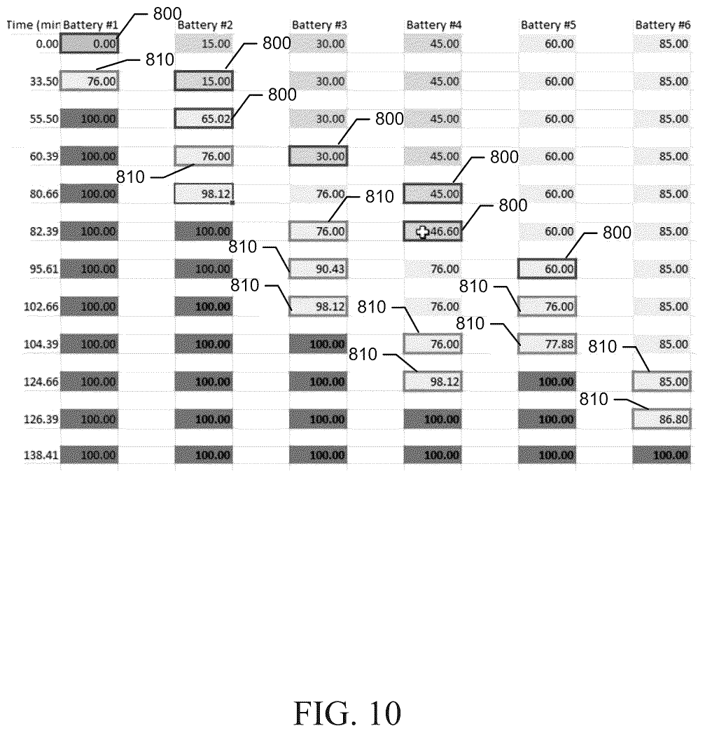

It is also noteworthy that the initial state of charge of the batteries will impact the timing, as noted above. FIGS. 9 and 10 each illustrate an example in which the same Stage 1 and Stage 2 parameters discussed above are applicable, but different initial states of charge exist for each of the batteries. In this regard, in FIG. 9, Battery #1 begins with an 85% SOC, Battery #2 begins with a 60% SOC, Battery #3 begins with a 45% SOC, Battery #4 begins with a 30% SOC, Battery #5 begins with a 15% SOC, and Battery #6 begins with a 0% SOC. The example of FIG. 10 flips the order of the SOCs of the batteries (i.e., Battery #6 begins with an 85% SOC, Battery #5 begins with a 60% SOC, Battery #4 begins with a 45% SOC, Battery #3 begins with a 30% SOC, Battery #2 begins with a 15% SOC, and Battery #1 begins with a 0% SOC).

Within FIGS. 9 and 10, batteries in Stage 1 are shown at each time step in box 800 (as in FIG. 8), and Batteries in Stage 2 are shown in box 810 (as in FIG. 8). The lengths of the time steps are changed based on the initial SOC for each cell, but the same paradigm otherwise still applies in that only one cell is in Stage 1 at any time, and no more than one other cell is in Stage 2 at any given time. Unsurprisingly, the total charge time is faster in both examples of FIGS. 9 and 10 relative to the example of FIG. 8. However, it should be appreciated that ordering batteries to charge empty cells first (as shown in FIG. 10) and place the highest initial SOC batteries in the last slots to be charged actually increases the overall charge time (i.e., to 138.41 minutes for the example of FIG. 10 from 123.38 minutes from the example of FIG. 9). In any case, it should be appreciated that any ordering (including random or no ordering) may be employed in connection with example embodiments. Moreover, it is also possible that some partially charged batteries may begin in the second stage, and it may be possible in any case to begin charging two batteries simultaneously even if both batteries start initially with a lower charging current. Finally, in some cases, if only two charging stages are employed, it may be preferred to keep the time spent in each stage approximately equal. However, if more than two stages are employed, it may be advantageous to change the duration and onset times of each stage.

The Stacked-Serial charging routine as described herein may retain the advantage of low complexity and heightened safety inherent in a CC/CV type routine for any SOC, while adding the ability to maintain high power output over the course of serially charging a multitude of batteries with relatively low power variation. The ability to maintain high power output with little variation continuously, allows for optimal system sizing and provides the potential for safe operation of parallel systems in order to maximize the utilization of available power from a supply without the demand for power ever exceeding what can be safely or practically supplied.

This routine also enables faster charging than standard serial charging methods as it has the parallel component of charging multiple batteries simultaneously. It also defines which portions of the charge profile can be run simultaneously and thus avoids the unrestricted power demands that can compound and limit standard parallel charging. The necessity to partition the charging profile encourages the use of higher charging currents at lower battery internal resistances, which significantly shortens charging time. It likewise encourages the use of lower charge currents at higher battery internal resistances, which avoids a protracted final CV period that occurs when the battery is at its highest SOC. This has the effect of further shortening the charging time while avoiding the accelerated aging that occurs from charging for longer durations at a high SOC

The hardware for a system that implements this routine only requires that battery connections be sized for the highest current demand portion of the charge routine. Using the basic system detailed above in FIG. 2, the first stage (i.e., the initial portion consisting of the CC-1 period) involves the highest current I_{CC-1}. The hardware for this charging system need only be designed to support currents up to I_{CC-1}, despite that the current output of the system usually being above I_{CC-1} and that for most of the charge cycle the current output of the system is the sum of I_{CC-1} and I_{CC-2}. Example embodiments may be used to charge batteries disposed in battery packs that can be useful in connection with battery powered tools or vehicles that may generally be referred to as battery powered outdoor power equipment. Outdoor power equipment that is battery powered, and battery powered tools generally, typically include battery packs that have a given voltage or power rating, and have physical characteristics that must match the receptacle of the device that is to be powered, which may be a handheld device (e.g., a chainsaw, trimmer, edger, power cutter, etc.) or a vehicle such as a lawnmower or other robotic device for performing lawn care functions. In order to achieve sufficient power, cells of the battery pack may be organized and interconnected (e.g., in an arrangement of series and/or parallel electrical connections) to group the cells within the battery pack into a battery in a manner that achieves desired electrical characteristics. The battery pack may be inserted into an aperture (e.g., a receptacle) of the piece of equipment that is to be powered so that the corresponding piece of equipment (e.g., hand-held, ride-on, or walk-behind outdoor power equipment) is enabled to be mobile. However, in some cases, the battery pack may be inserted into a backpack or other carrying implement that the equipment operator may wear, and the backpack may have an interface portion to be inserted into the aperture of the piece of equipment. Thus, the battery pack is typically both removable and rechargeable.

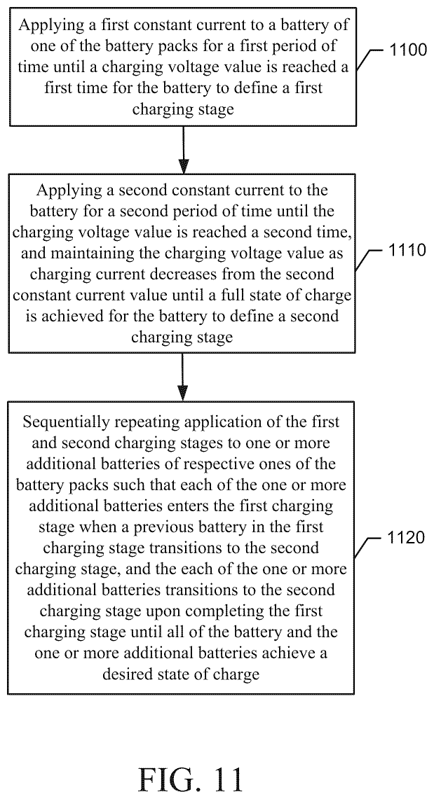

Accordingly, in one example embodiment, a charging system for charging a plurality of battery packs may be provided. The system may include a battery charger for converting AC input power into DC output power for charging the battery packs, and an expansion array operably coupled to the battery charger to receive the DC output power. The expansion array may include a plurality of charge ports into which respective ones of the battery packs are installed for charging and a power controller. The power controller may be configured for employing a method of charging the battery packs that is further illustrated in the block diagram of FIG. 11. In this regard, as shown in FIG. 11, the method may include applying a first constant current to a battery of one of the battery packs for a first period of time until a charging voltage value is reached a first time for the battery to define a first charging stage at operation 1100. The method may further include applying a second constant current to the battery for a second period of time until the charging voltage value is reached a second time, and maintaining the charging voltage value as charging current decreases from the second constant current value until a full state of charge is achieved for the battery to define a second charging stage at operation 1110. The method may also include sequentially repeating application of the first and second charging stages to one or more additional batteries of respective ones of the battery packs such that each of the one or more additional batteries enters the first charging stage when a previous battery in the first charging stage transitions to the second charging stage, and the each of the one or more additional batteries transitions to the second charging stage upon completing the first charging stage until all of the battery and the one or more additional batteries achieve a desired state of charge at operation 1120. Notably, although the charging voltage value is the same in the example of FIG. 11, the second time the charging voltage value is reached, it could be a different (e.g., slightly lower) value in other examples. Moreover, although the charging voltage values is maintained during the second stage in the example above, the second stage may end without the constant voltage step in some cases. Thus, for example, two or more constant current sequences could be repeated in some alternative embodiments (i.e., with or without a constant voltage step).

In some cases, modifications or amplifications may further be employed as optional alterations or augmentations to the description above. These alterations or augmentations may be performed exclusive of one another or in any combination with each other. In some cases, such modifications or amplifications may include (1), the first constant current being larger than the second constant current. In an example embodiment (2), the first constant current may be more than double the second constant current (e.g., 3 to 5 times larger in some cases). In some cases (3), the first period of time and the second period of time may be approximately equal (e.g., to try to match the length of the first and second stages to minimize the time that only one battery is being charged). However, in some embodiments (4), the first period of time and the second period of time may be unequal. In an example embodiment (5), only one battery among the battery and the one or more additional batteries is in the first charging stage and only one battery among the battery and the one or more additional batteries is in the second charging stage at any given time. In some cases (6), the expansion array may include six or more charge ports. In an example embodiment (7), two or more instances of the expansion array may be operably coupled to the battery charger.

In an example embodiment, some, any or all of modifications/amplifications (1) to (7) may be employed in any combination with each other. It is also noteworthy that some systems and methods may include a precharge stage, which is generally of short duration when applied, but nevertheless may exist. When employed, the precharge stage may utilize a constant current or constant voltage application that occurs prior to the first stage discussed above. Thus, it should be self-evident that in those situations the first and second stages are “first” and “second” relative to each other and not necessarily in absolute terms. However, in still other examples, the first and second stages may be absolutely the first and second stages applied.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A method of charging a plurality of removable battery packs, the method comprising:
applying a first constant current to a battery for a first period of time until a first charging voltage value is reached for the battery to define a first charging stage;
applying a second constant current to the battery for a second period of time until a second charging voltage value is reached for the battery to define a second charging stage; and
sequentially repeating application of the first and second charging stages to one or more additional batteries such that each of the one or more additional batteries enters the first charging stage when a previous battery in the first charging stage transitions to the second charging stage, and the each of the one or more additional batteries transitions to the second charging stage upon completing the first charging stage until all of the battery and the one or more additional batteries achieve a desired state of charge.

2. The method of claim 1, wherein the first constant current is larger than the second constant current.

3. The method of claim 2, wherein the first constant current is more than double the second constant current.

4. The method of claim 1, wherein the first period of time and the second period of time are approximately equal, or wherein the first period of time and the second period of time are not equal.

5. The method of claim 1, wherein the first and second charging voltage values are equal, and
wherein the second charging stage further includes maintaining the second charging voltage value as charging current decreases from the second constant current value until a full state of charge is achieved.

6. The method of claim 1, wherein only one battery among the battery and the one or more additional batteries is in the first charging stage and only one battery among the battery and the one or more additional batteries is in the second charging stage at any given time.

7. An expansion array for enabling charging of a plurality of removable battery packs via a single charger to which the expansion array is operably coupled, the expansion array comprising a plurality of charge ports into which respective ones of the battery packs are installed for charging, and a power controller configured for:
applying a first constant current to a battery inserted into one of the charge ports for a first period of time until a first charging voltage value is reached for the battery to define a first charging stage;
applying a second constant current to the battery for a second period of time until a second charging voltage value is reached for the battery to define a second charging stage; and
sequentially repeating application of the first and second charging stages to one or more additional batteries inserted into respective other ones of the charge ports such that each of the one or more additional batteries enters the first charging stage when a previous battery in the first charging stage transitions to the second charging stage, and the each of the one or more additional batteries transitions to the second charging stage upon completing the first charging stage until all of the battery and the one or more additional batteries achieve a desired state of charge.

8. The expansion array of claim 7, wherein the first constant current is larger than the second constant current.

9. The expansion array of claim 8, wherein the first constant current is more than double the second constant current.

10. The expansion array of claim 7, wherein the first period of time and the second period of time are approximately equal or are not equal.

11. The expansion array of claim 7, wherein the first and second charging values are equal, and
wherein the second charging stage further includes maintaining the second charging voltage value as charging current decreases from the second constant current value until a full state of charge is achieved.

12. The expansion array of claim 7, wherein only one battery among the battery and the one or more additional batteries is in the first charging stage and only one battery among the battery and the one or more additional batteries is in the second charging stage at any given time.

13. A charging system for charging a plurality of battery packs, the system comprising:
a battery charger for converting AC input power into DC output power for charging the battery packs; and
an expansion array operably coupled to the battery charger to receive the DC output power, the expansion array comprising a plurality of charge ports into which respective ones of the battery packs are installed for charging,
wherein the expansion array comprises a power controller configured for:
applying a first constant current to a battery of one of the battery packs for a first period of time until a first charging voltage value is reached for the battery to define a first charging stage;
applying a second constant current to the battery for a second period of time until a second charging voltage value is reached for the battery to define a second charging stage; and
sequentially repeating application of the first and second charging stages to one or more additional batteries of respective ones of the battery packs such that each of the one or more additional batteries enters the first charging stage when a previous battery in the first charging stage transitions to the second charging stage, and the each of the one or more additional batteries transitions to the second charging stage upon completing the first charging stage until all of the battery and the one or more additional batteries achieve a desired state of charge.

14. The system of claim 13, wherein the first constant current is larger than the second constant current.

15. The system of claim 14, wherein the first constant current is more than double the second constant current.

16. The system of claim 13, wherein the first period of time and the second period of time are approximately equal or are not equal.

17. The system of claim 13, wherein the first and second charging values are equal or unequal, and
wherein the second charging stage further includes maintaining the second charging voltage value as charging current decreases from the second constant current value until a full state of charge is achieved.

18. The system of claim 13, wherein only one battery among the battery and the one or more additional batteries is in the first charging stage and only one battery among the battery and the one or more additional batteries is in the second charging stage at any given time.

19. The system of claim 13, wherein the expansion array comprises six or more charge ports.

20. The system of claim 13, wherein two or more instances of the expansion array are operably coupled to the battery charger.
